(19) United States
(12) Patent Application Publication
(10) Pub. No.: US 2018/0321890 A1
(43) Pub. Date: Nov. 8, 2018

(54) ASYNCHRONOUS UPDATES OF LIVE MEDIA INFORMATION

(71) Applicant: International Business Machines Corporation, Armonk, NY (US)

(72) Inventors: SEAN C. ANGLIN, BROOKLYN, NY (US); CHRISTOPHER R. FLORENCE, CARY, NC (US); WISAM MOHAMMED, RALEIGH, NC (US)

(21) Appl. No.: 15/586,736

(22) Filed: May 4, 2017

(51) Int. Cl. G06F 3/14; H04N 21/2187

(52) U.S. Cl. CPC G06F 3/1423; H04N 21/2187

(57) ABSTRACT

A system for controlling a display of content is provided. The system includes a display device and a control element. The display device includes first and second display units. The control element includes first and second controllers. The first and second controllers are coupled to the first and second display units, respectively. The first controller is configured to pause a display of first content on the first display unit to thereby initiate a lag between the display of the first content on the first display unit and a real-world occurrence of the first content. The second controller is configured to prevent a display of second content, which is related to the first content but which is not subject to the lag, on the second display unit while the lag persists.

### BACKGROUND

The present invention generally relates to media information and, more specifically, to asynchronous updates of live media information.

In computer displays, filmmaking, television production, and other kinetic displays, scrolling is sliding text, images or video across a monitor or display unit in vertical or horizontal directions. As such, “scrolling” does not change the layout of the displayed text or pictures, but moves (pans or tilts) the user's view across what is apparently a larger image that is not wholly seen. Within the context of television programs, scrolling is often used in the form of a news ticker that is presented towards the bottom of the picture to display various newsworthy items. These newsworthy items are scrolled sideways across the screen and delivering short-form content to the viewer.

### SUMMARY

Embodiments of the present invention are directed to a system for controlling a display of content is provided. A non-limiting example of the system includes a display device and a control element. The display device includes first and second display units. The control element includes first and second controllers. The first and second controllers are coupled to the first and second display units, respectively. The first controller is configured to pause a display of first content on the first display unit to thereby initiate a lag between the display of the first content on the first display unit and a real-world occurrence of the first content. The second controller is configured to prevent a display of second content, which is related to the first content but which is not subject to the lag, on the second display unit while the lag persists.

Embodiments of the present invention are directed to a method for controlling a display of content. A non-limiting example of the method includes pausing a display of first content on a first display unit to initiate a lag between the display of the first content on the first display unit and a real-world occurrence of the first content. The non-limiting example of the method further includes preventing a display of second content, which is related to the first content but which is not subject to the lag, on a second display unit while the lag persists.

Embodiments of the present invention are directed to a computer program product for controlling a display of content. A non-limiting example of the computer program product includes a processing circuit and a memory unit. The memory unit has executable instructions stored thereon, which, when executed cause the processing circuit to perform a method. The method includes pausing a display of first content on a first display unit to initiate a lag between the display of the first content on the first display unit and a real-world occurrence of the first content. The method further includes preventing a display of second content, which is related to the first content but which is not subject to the lag, on a second display unit while the lag persists.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a system for controlling a display of content according to one or more embodiments of the present invention;

FIG. 2 depicts a system for controlling a display of content according to one or more embodiments of the present invention

FIG. 3 depicts a system for controlling a display of content according to one or more embodiments of the present invention;

FIG. 4 illustrates an operation of the system of FIG. 2;

FIG. 5 illustrates an operation of the system of FIG. 3;

FIG. 6 is a schematic diagram illustrating components of first and second controllers in accordance with one or more embodiments of the present invention; and

FIG. 7 is a flow diagram illustrating an asynchronous display of live media information in accordance with one or more embodiments of the present invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Turning now to an overview of technologies that are more specifically relevant to aspects of the invention, consumers of audio/visual content often have the ability to pause such content. In particular, a viewer can pause live television and/or media streams. This can lead to a problem, however, since live broadcasts continue while the pause is in effect and the viewer's other media sources can still broadcast updates of the live broadcast to the viewer. If the viewer should happen to tune into those other media sources when the updates are broadcast, the viewer will be aware of incidents occurring in the live broadcast that he may not want to know about. For instance, a viewer may be watching a football game and have a live scrolling sports ticker at a bottom of his screen. If that viewer pauses the game for a few minutes but his pause does not affect the scrolling sports ticker, when the viewer returns to the game and plays it from the moment he pause, the scrolling sports ticker might display a change in the score that has not yet occurred in the playing of the game that the viewer has actually seen. This could ruin the experience of watching the game for the viewer. As another example, if a viewer pauses a live sporting event but then logs onto social media, his social media stream may include updates that relate to game play he has not yet seen. This could, again, ruin the experience of watching the game for the viewer.

The above-described aspects of the invention address the shortcomings of the prior art by providing for a system whereby a consumer of live content is able to pause the live content for some unspecified period of time and then play the live content from that point later. During the pause and until the consumer has “caught up” to the live content, various media streams will be controlled and prevented from displaying updates that are related to the live content the consumer has paused. This will avoid the possibility of those updates negatively affecting the consumer's viewing experience.

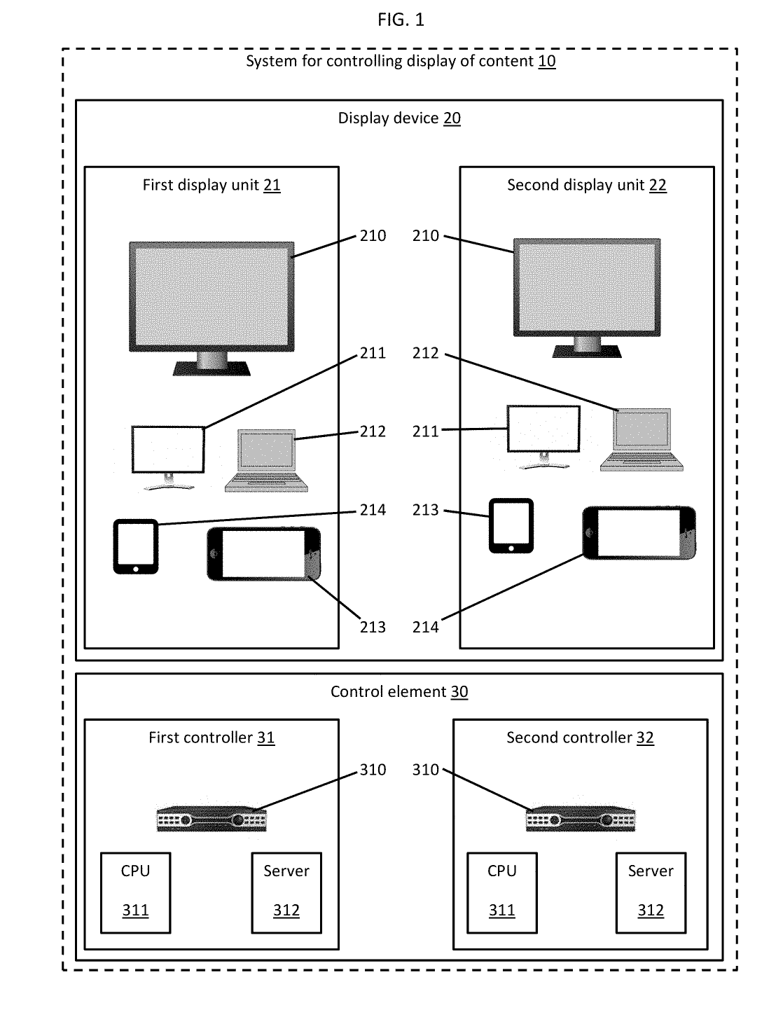

Turning now to a more detailed description of aspects of the present invention, FIG. 1 depicts a system 10 for controlling a display of content according to embodiments of the invention.

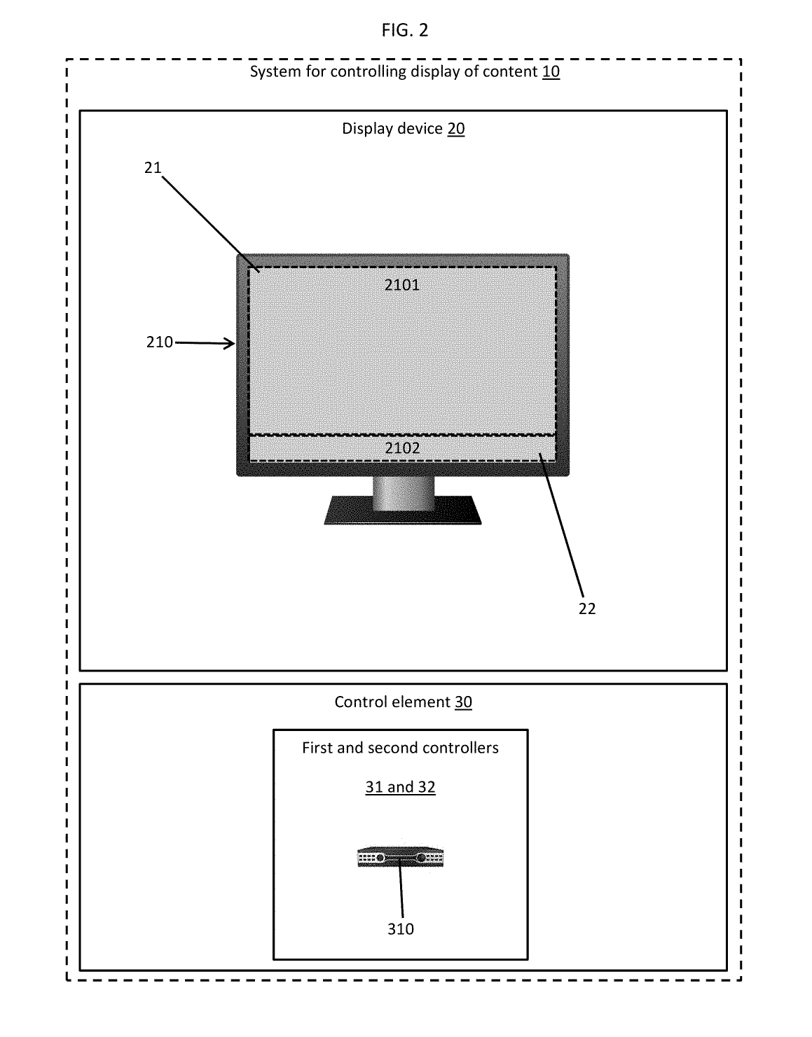

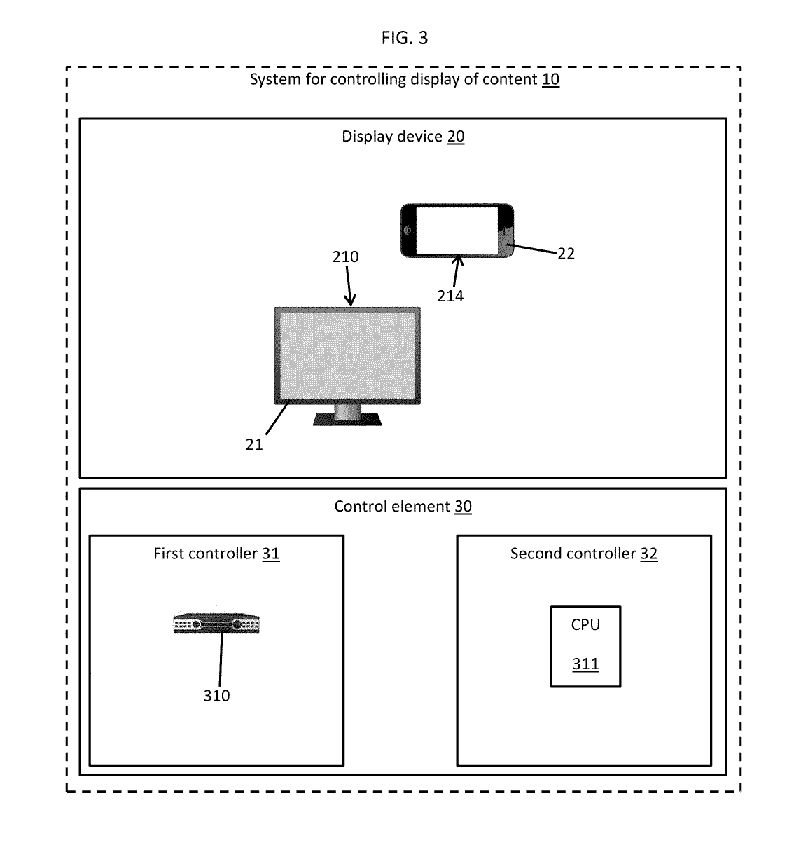

As shown in FIG. 1 and with reference to FIGS. 2 and 3, the system 10 includes a display device 20 and a control element 30. The display device 20 includes a first display unit 21 and a second display unit 22. The first display unit 21 may include or be provided as at least one of a television 210, a computer monitor 211, a portable computing device 212, a tablet 213 and a smartphone 214. The second display unit 22 may similarly include or be provided as at least one of the television 210, the computer monitor 211, the portable computing device 212, the tablet 213 and the smartphone 214. The control element 30 includes a first controller 31 and a second controller 32. The first controller 31 may include or be provided as at least one of a receiver, a DVR or a TiVo™ (hereinafter referred to as a “DVR”) 310, a processing unit and display driver (hereinafter referred to as a “CPU”) 311 and a server 312. The second controller 32 may similarly include or be provided as at least one of the DVR 310, the CPU 311 and the server 312.

The first controller 31 is operably coupled to at least the first display unit 21 and the second controller 32 is operably coupled to at least the second display unit 22.

In accordance with one or more embodiments of the present invention, the first display unit 21 may be provided as a portion of the television 210 with the first controller 31 correspondingly provided as the DVR 310 and the second display unit 22 may be provided as another portion of the television 210 with the second controller 32 correspondingly provided as the DVR 310 (see FIG. 2 in which the second display unit 22 is effectively framed in or superimposed over the first display unit 21). Alternatively, in accordance with one or more embodiments of the present invention, the first display unit 21 may be provided as the television 210 with the first controller 31 correspondingly provided as the DVR 310 and the second display unit 22 may be provided as the smartphone 214 with the second controller correspondingly provided as the CPU 311 (see FIG. 3 in which the second display unit 22 is effectively remote from the first display unit 21).

For purposes of clarity and brevity, the following description will relate to the cases shown in FIGS. 2 and 3.

In the case of FIG. 2, the DVR 310 is configured to receive multiple broadcast signals from an external source and to transmit those multiple broadcast signals to the television 210. These multiple broadcast signals may include, for example, a live sporting event signal and a scrolling sports news ticker signal that includes live score updates of the live sporting event along with other live sporting events. The television 210 displays a moving image of the live sporting event signal in a first portion 2101 of its screen and displays a moving image of the scrolling sports news ticker signal in a second portion 2102 of its screen, which is framed in or superimposed over the first portion 2101 of the screen. During normal operation, the displays of the moving image of the live sporting event signal and the moving image of the scrolling sports news ticker signal in the first and second portions 2101 and 2102 of its screen are synchronous. That is, as scoring occurs in the live sporting event, the scrolling sports news ticker will quickly include an updated score that corresponds to the scoring.

In the case of FIG. 3, the DVR 310 is configured to receive the live sporting event signal and to transmit that signal to the television 210 whereupon the television 210 displays a moving image of the live sporting event signal on its screen. The CPU 311 is configured to receive social media data signals by way of a networking unit to which the CPU 311 is coupled whereupon the smartphone 214 displays social media updates (e.g., Facebook™ status updates or Twitter™ tweets) within the corresponding social media applications. Again, during normal operation, the displays of the moving image of the live sporting event signal on the screen of the television 210 and the display of the social media updates are synchronous. That is, as scoring occurs in the live sporting event, Facebook™ status updates or Twitter™ tweets will be generated and displayed.

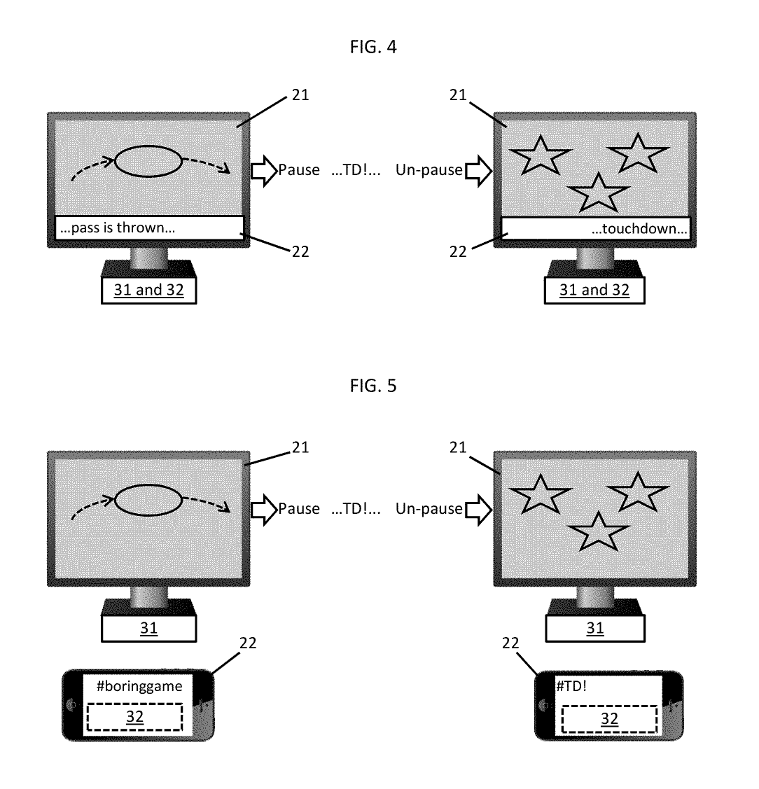

With reference to FIG. 4 and, in accordance with one or more further embodiments of the present invention, the first controller 31 (i.e., the DVR 310) is configured to selectively pause and then selectively un-pause and play or fast-forward through a display of first content on the first display unit 21 (i.e., the display of the moving image of the live sporting event signal on the first portion 2101 of the screen of the television 210 as in FIG. 2) to thereby initiate a lag between the display of the first content on the first display unit 21 following the un-pausing and a real-world occurrence of the first content. Here, the second controller 32 (i.e., the DVR 310 once again) is configured to selectively prevent a display of second content (i.e., the display of the scrolling sports news ticker signal on the second portion 2102 of the screen of the television 210 as in FIG. 2), which is related to the first content but which is not subject to the lag, on the second display unit 22 while the lag persists.

With reference to FIG. 5 and, in accordance with one or more further embodiments of the present invention, the first controller 31 (i.e., the DVR 310) is configured to selectively pause and then selectively un-pause and play or fast-forward through a display of first content on the first display unit 21 (i.e., the display of the moving image of the live sporting event signal on the screen of the television 210 as in FIG. 3) to thereby initiate a lag between the display of the first content on the first display unit 21 following the un-pausing and a real-world occurrence of the first content. Here, the second controller 32 (i.e., the CPU 311) is configured to selectively prevent a display of second content (i.e., the display of the social media updates by the smartphone 214 as in FIG. 3), which is related to the first content but which is not subject to the lag, on the second display unit 22 while the lag persists.

In accordance with one or more still further embodiments of the present invention, the second controller 32 may be configured to recognize that the second content is related to the first content. This can be achieved by natural language processing of the first and second content by the second controller 32 or by executions of other similar algorithms. In an exemplary case, where the first content is a live broadcast of a professional football game between teams 1 and 2, the second content could be recognized by the second controller 31 as being any social media updates containing the terms “professional football,” “team 1,” “team 2,” “score,” “touchdown,” etc.

That is, as shown in FIG. 4, once the first controller 31 selectively pauses the display of the first content on the first display unit 21 (i.e., the first portion 2101 of the screen of the television 210) following, for example, a user pressing a pause button on a remote control, the real-world occurrence of the first content continues even while the first display unit 21 is paused such that notable events may occur during the pause with the user not being aware of those notable events in real-time. If the pause persists for five minutes, for example, the resulting lag between the un-paused display of the first content on the first display unit 21 is five minutes long but can be shortened if the user fast-forwards through portions of the un-paused display. The selective prevention of the display of the second content on the second display unit 22 (i.e., the second portion 2102 of the screen of the television 210) while the lag persists serves to prevent an incident in which the user is undesirably made aware of the notable events by the scrolling sports news ticker at least until the user catches up to the notable events during the un-paused playing and possible fast-forwarding through of the first content.

Similarly, as shown in FIG. 5, once the first controller 31 selectively pauses the display of the first content on the first display unit 21 (i.e., the television 210) following, for example, the user pressing the pause button on the remote control, the real-world occurrence of the first content continues even while the first display unit 21 is paused such that notable events may occur during the pause with the user not being aware of those notable events in real-time. If the pause persists for five minutes, for example, the resulting lag between the un-paused display of the first content on the first display unit 21 is five minutes long but can be shortened if the user fast-forwards through portions of the un-paused display. The selective prevention of the display of the second content on the second display unit 22 (i.e., the smartphone 214) while the lag persists serves to prevent an incident in which the user is undesirably made aware of the notable events by the social media updates at least until the user catches up to the notable events during the un-paused playing and possible fast-forwarding through of the first content.

With continued reference to FIGS. 4 and 5 and, in accordance with one or more further embodiments of the present invention, the second controller 32 (i.e., the CPU 311) is further configured to identify a synchronized display of the second content on the second display unit 22 with a lagging display of the first content on the first display unit 21 and to permit the synchronized display of the second content on the second display unit 22 while the lag persists. That is, in the examples provided above, once the user un-pauses the display of the first content on the first display unit 21, the second controller 32 will effectively permit the display of the second content items which are synchronized with the actual items of the first content being displayed.

Thus, in the case of FIG. 4, if the first content items include two sequential touchdowns, the second controller 32 may permit the display of first updated touchdown score in the scrolling sports news ticker once the first touchdown is displayed and then may permit the display of the second updated touchdown score in the scrolling news ticker once the second touchdown is displayed. Similarly, in the case of FIG. 5, if the first content items include two sequential touchdowns, the second controller 32 may permit the display of social media updates associated with the first touchdown once the first touchdown is displayed and then may permit the social media updates associated with the second touchdown once the second touchdown is displayed.

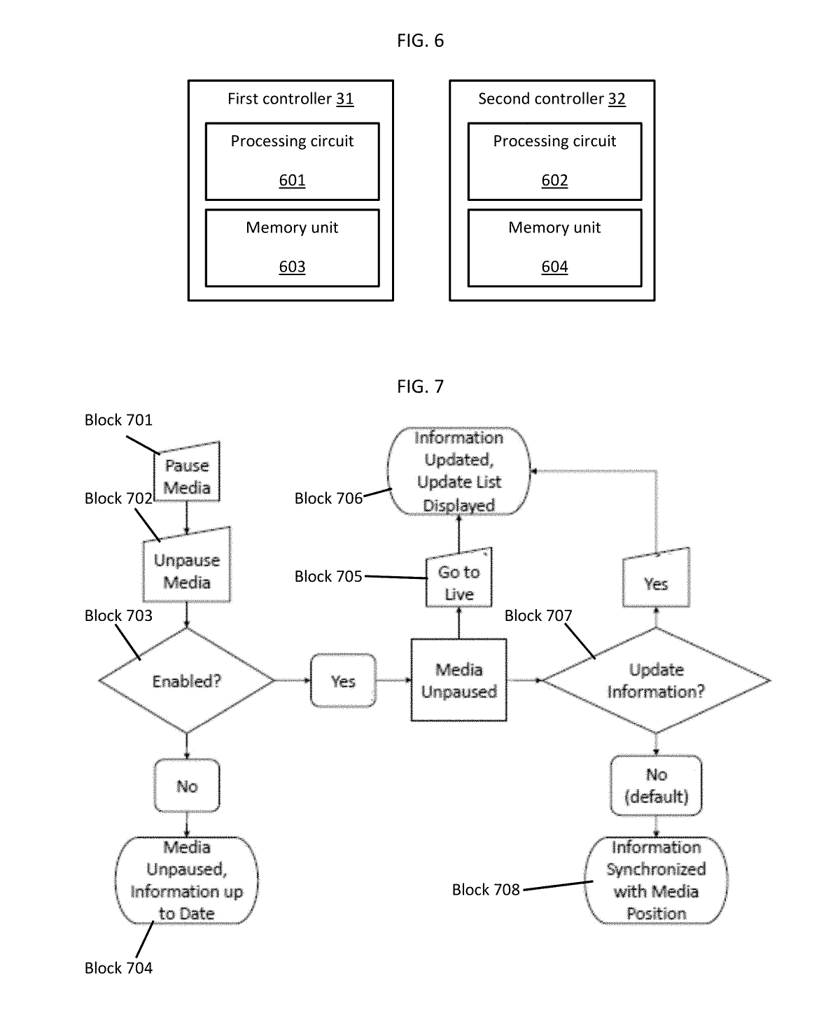

With reference to FIG. 6, the first and second controllers 31 and 32 may be provided as computer program products and include processing circuits 601 and 602, respectively, as well as memory units 603 and 604, respectively. The memory units 603 and 604 each have executable instructions stored thereon, which, when executed, cause the processing circuits 601 and 602 to operate as described herein. For example, the executable instructions of memory unit 603 may be configured to cause the processing circuit 601 to selectively pause a display of the first content on the first display unit 21 to initiate a lag between the display of the first content on the first display unit 21 and a real-world occurrence of the first content. Meanwhile, the executable instructions of memory unit 604 may be configured to cause the processing circuit 602 to prevent the display of the second content, which is related to the first content but which is not subject to the lag, on the second display unit 22 while the lag persists, to identify the synchronized display of the second content on the second display unit 22 with a lagging display of the first content on the first display unit 21 and to permit the synchronized display of the second content on the second display unit 22 while the lag persists.

With reference to FIG. 7, a method of asynchronously updating live media information is provided. As shown in FIG. 7, the method includes selectively pausing the displaying of the first content on the first display unit 21 via the first controller 31 (block 701) and eventually selectively un-pausing the displaying of the first content on the first display unit 21 via the first controller 31 (block 702). The method further includes determining if the “prevention” capability of the second controller 32 is enabled (block 703) and, if not, operating the second controller 32 to permit the display of the second content uninterrupted on the second display unit 22 (block 704). If the “prevention” capability is enabled, the method includes operating the second controller 32 to detect that the user decides to catch up to a live stream (block 705) and permitting an updating and a displaying of the second content to the user on the second display unit 22 (block 706). On the other hand, if it is detected that the user does not want to catch up, the second controller 32 is operated to ask the user if the user wants the display of the second content delayed (block 707). If not, control reverts to the permitting of the updating and the displaying of the second content to the user on the second display unit 22 of block 706. If so, the second controller 32 permits a display of only the second content items that are synchronized with events of the first content that are displayed by the first display unit 21 on the second display unit 22 (block 708).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A system for controlling a display of content, comprising:
a display device comprising first and second display units; and
a control element comprising first and second controllers,
the first and second controllers being coupled to the first and second display units, respectively,
the first controller being configured to pause a display of first content on the first display unit to thereby initiate a lag between the display of the first content on the first display unit and a real-world occurrence of the first content, and
the second controller being configured to prevent a display of second content, which is related to the first content but which is not subject to the lag, on the second display unit while the lag persists.

2. The system according to claim 1, wherein the first content comprises a live broadcast of an event and the second content comprises at least one of scrolling news related to the event and social media updates related to the event.

3. The system according to claim 1, wherein the second controller is further configured to recognize whether the second content is related to the first content.

4. The system according to claim 1, wherein each of the first and second display units comprises at least one of a television, a computer monitor, a portable computing device, a tablet and a smartphone.

5. The system according to claim 1, wherein the second display unit is framed in or superimposed over a portion of the first display unit.

6. The system according to claim 1, wherein the second display unit is remote from the first display unit.

7. The system according to claim 1, wherein each of the first and second controllers comprises at least one of a receiver, a DVR, a TiVo™, a display driver and a server.

8. The system according to claim 1, wherein the second controller is remote from the first controller.

9. The system according to claim 1, wherein:
the first controller is configured to selectively pause the display of the first content on the first display unit, and
the second controller is configured to selectively prevent the display of the second content on the second display unit.

10. The system according to claim 1, wherein the second controller is further configured to:
identify a synchronized display of the second content on the second display unit with a lagging display of the first content on the first display unit, and
permit the synchronized display of the second content on the second display unit while the lag persists.

11. A method of controlling a display of content, comprising:
pausing a display of first content on a first display unit to initiate a lag between the display of the first content on the first display unit and a real-world occurrence of the first content; and
preventing a display of second content, which is related to the first content but which is not subject to the lag, on a second display unit while the lag persists.

12. The method according to claim 11, wherein the first content comprises a live broadcast of an event and the second content comprises at least one of scrolling news related to the event and social media updates related to the event.

13. The method according to claim 11, further comprising recognizing that the second content is related to the first content.

14. The method according to claim 11, wherein:
the pausing comprises selectively pausing the display of the first content on the first display unit, and
the preventing comprises selectively preventing the display of the second content on the second display unit.

15. The method according to claim 11, further comprising:
identifying a synchronized display of the second content on the second display unit with a lagging display of the first content on the first display unit, and
permitting the synchronized display of the second content on the second display unit while the lag persists.

16. A computer program product for controlling a display of content, the computer program product comprising:
a processing circuit; and
a memory unit having executable instructions stored thereon, which, when executed, cause the processing circuit to perform a method comprising:
pausing a display of first content on a first display unit to initiate a lag between the display of the first content on the first display unit and a real-world occurrence of the first content; and
preventing a display of second content, which is related to the first content but which is not subject to the lag, on a second display unit while the lag persists.

17. The computer program product according to claim 16, wherein the first content comprises a live broadcast of an event and the second content comprises at least one of scrolling news related to the event and social media updates related to the event.

18. The computer program product according to claim 16, wherein the method further comprises recognizing that the second content is related to the first content.

19. The computer program product according to claim 16, wherein:
the pausing comprises selectively pausing the display of the first content on the first display unit, and
the preventing comprises selectively preventing the display of the second content on the second display unit.

20. The computer program product according to claim 16, wherein the method further comprises:
identifying a synchronized display of the second content on the second display unit with a lagging display of the first content on the first display unit, and
permitting the synchronized display of the second content on the second display unit while the lag persists.
